(19) United States
(12) Patent Application Publication
(10) Pub. No.: US 2014/0305317 A1
(43) Pub. Date: Oct. 16, 2014

(54) GRILL DEVICE

(71) Applicant: TSANN KUEN ZHANGZHOU, Fujian (CN)

(72) Inventor: Hui-Jie ZHENG, Fujian (CN)

(73) Assignee: TSANN KUEN ZHANGZHOU, Fujian (CN)

(21) Appl. No.: 14/246,228

(22) Filed: Apr. 7, 2014

(30) Foreign Application Priority Data
Apr. 12, 2013 (CN) 201320185597.2

(51) Int. Cl. A47J 37/06

(52) U.S. Cl. CPC A47J 37/0611
USPC 99/372

(57) ABSTRACT

A grill device includes a first housing, a first grilling plate, a second housing, a second grilling plate, at least one first engaging member, and at least one second engaging member. The first grilling plate is mounted on the first housing. The second housing is pivotally connected to the first housing. The second grilling plate is mounted on the second housing, is movable toward and away from the second housing, and faces the first grilling plate. The first engaging member is disposed on the first housing. The second engaging member is disposed on the second housing and is configured to removably engage the first engaging member so as to lock the first housing to the second housing.

### CROSS-REFERENCE TO RELATED APPLICATION

This application claims priority to Chinese Application No. 201320185597.2, filed on Apr. 12, 2013.

### BACKGROUND OF THE INVENTION

1. Field of the Invention

This invention relates to a cooking device, more particularly to a grill device.

2. Description of the Related Art

A conventional grill device usually includes pivotally-connected upper and lower housings mounted respectively with upper and lower grilling plates. However, when the upper grilling plate is superimposed on the lower grilling plate to cook food disposed therebetween, only the weight of the upper housing and the upper grilling plate is exerted on the food to be cooked. Consequently, if the food is relatively hard, the weight of the upper housing and the upper grilling plate maybe counteracted by the food, and thus, the upper housing and the upper grilling plate may not fittingly lie on the food, causing relatively small contact areas between the food and the upper grilling plate and between the food and the lower grilling plate. Moreover, most heat from the upper and lower grilling plates cannot be transferred to the food efficiently and effectively, thus causing waste of electric power.

### SUMMARY OF THE INVENTION

Therefore, the object of the present invention is to provide a grill device capable of cooking the food with a relatively high efficiency.

According to this invention, a grill device includes a first housing, a first grilling plate, a second housing, a second grilling plate, at least one first engaging member, and at least one second engaging member. The first grilling plate is mounted on the first housing. The second housing is pivotally connected to the first housing. The second grilling plate is mounted on the second housing, is movable toward and away from the second housing, and faces the first grilling plate. The first engaging member is disposed on the first housing. The second engaging member is disposed on the second housing and is configured to removably engage the first engaging member so as to lock the first housing to the second housing.

### BRIEF DESCRIPTION OF THE DRAWINGS

Other features and advantages of the present invention will become apparent in the following detailed description of the preferred embodiment of the invention, with reference to the accompanying drawings, in which:

FIG. 1 is a perspective view of a preferred embodiment of a grill device according to the present invention;

FIG. 2 is an exploded perspective view of the preferred embodiment;

FIG. 3 is a perspective view for illustrating a connecting member and a pivoting member of the grill device;

FIG. 4 is a schematic sectional view of the preferred embodiment, illustrating a first grilling plate and a second grilling plate being biased toward the first grilling plate; and

FIG. 5 is a schematic sectional view of the preferred embodiment, illustrating the food being tightly clamped between the first and second grilling plates.

### DETAILED DESCRIPTION OF THE PREFERRED EMBODIMENT

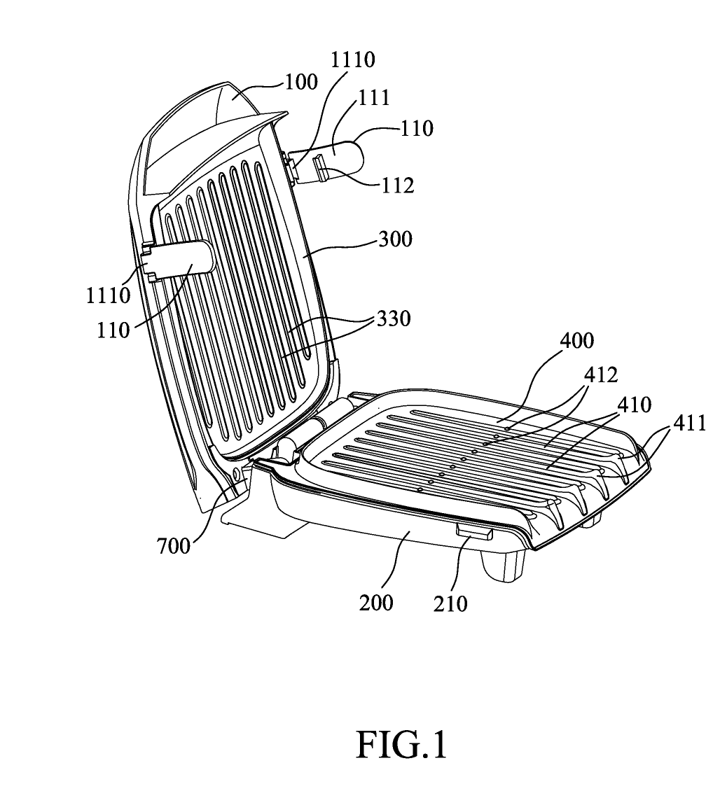

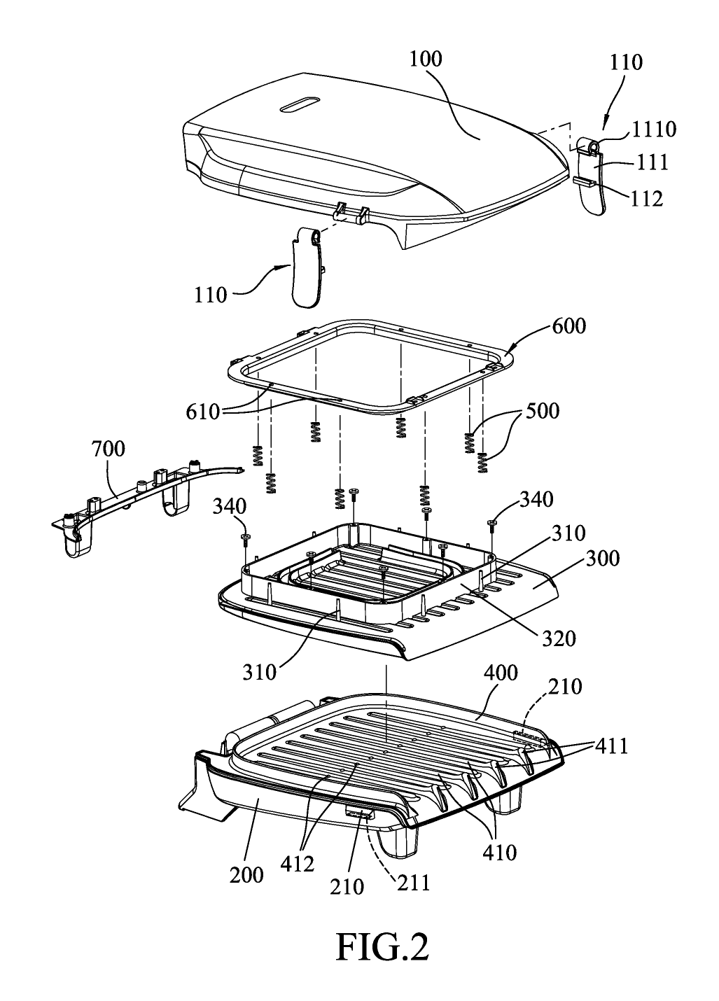

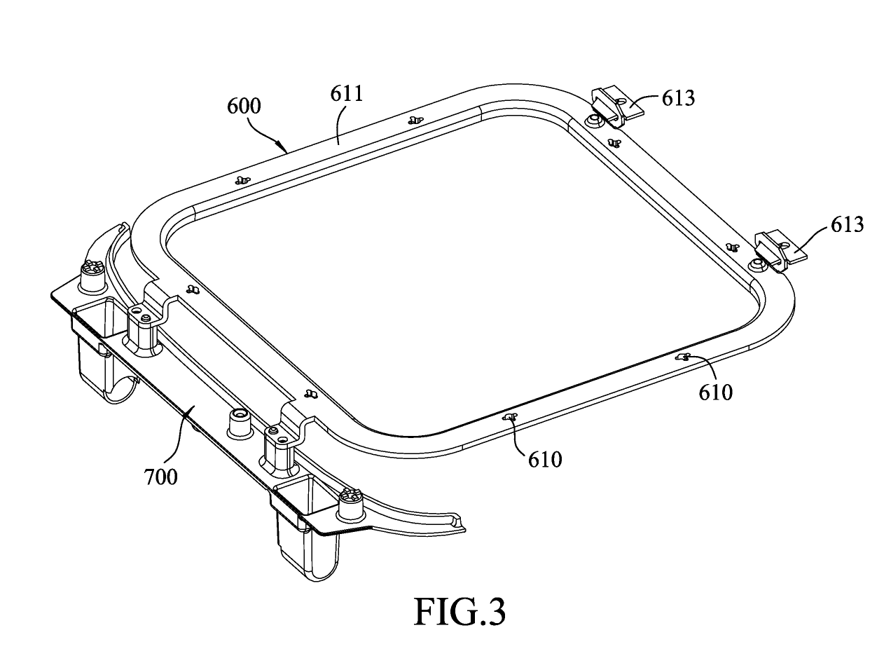

Referring to FIGS. 1 to 4, the preferred embodiment of the grill device according to the present invention includes a first housing 200, a first grilling plate 400, a plurality of biasing members 500, a connecting member 600, a pivoting member 700, a second housing 100, a second grilling plate 300, two first engaging members 210, and two second engaging members 110.

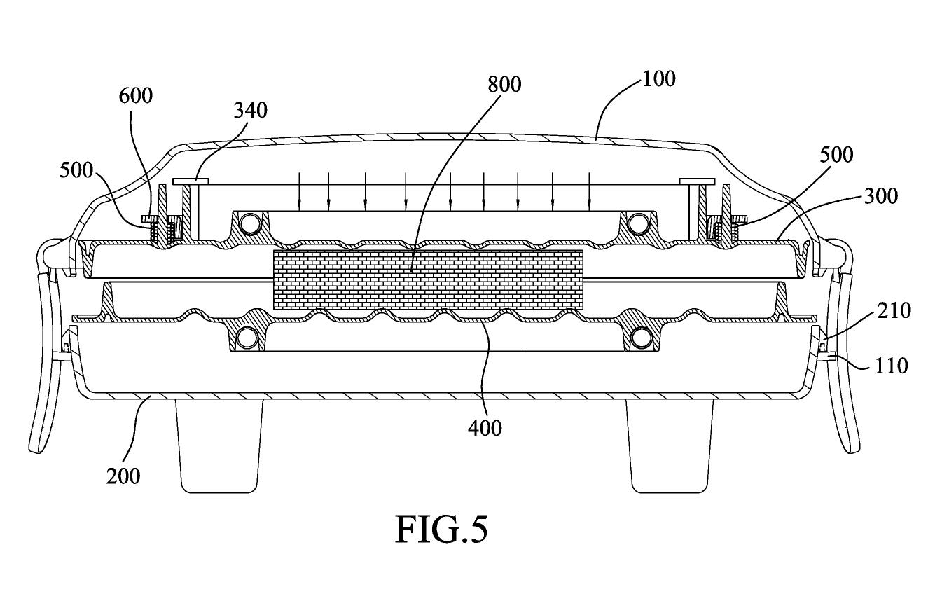

The second housing 100 is pivotally connected to the first housing 200 via the pivoting member 700. The first grilling plate 400 is mounted on the first housing 200, and includes a plurality of spaced-apart ridges 410, a plurality of blocks 411, and a plurality of protrusions 412. The blocks 411 extend respectively from distal ends of the ridges 410 away from the pivoting member 700, and cooperate with the protrusions 412 to prevent the food 800 (see FIG. 5) disposed on the first grilling plate 400 from sliding off the first grilling plate 400.

The connecting member 600 is configured as a frame that interconnects the second housing 100 and the second grilling plate 300, and is connected fixedly to the second housing 100 via two joint members 613. The connecting member 600 is formed with a plurality of through holes 610 arranged along the connecting member 600.

The second grilling plate 300 is mounted on the second housing 100 via the connecting member 600, is movable toward and away from the second housing 100, and faces the first grilling plate 400. The second grilling plate 300 includes a plurality of pillars 310, a confining member 320, a plurality of ribs 330, and a plurality of limiting members 340.

The ribs 330 are spaced apart from one another, and protrude toward the first grilling plate 400. The confining member 320 protrudes toward the second housing 100 opposite to the ribs 330, and extends along the connecting member 600. The limiting members 340 extend from a periphery of the confining member 320 toward the connecting member 600, and are removably attached to the connecting member 600 to confine the connecting member 320. The pillars 310 surround the confining member 320, and extend through the through holes 610 formed in the connecting member 600, respectively.

The biasing members 500 are disposed between the connecting member 600 and the second grilling plate 300, and are respectively sleeved on the pillars 310 for biasing the second grilling plate 300 away from the connecting member 600.

In this embodiment, a plurality of screws fastened to the confining member 320 have respective head portions serving as the limiting members 340, respectively, to limit movement of the second grilling plate 300 in a direction toward and away from the second housing 100. The configuration of the limiting members 340 is not limited in this respect.

The first engaging members 210 are disposed on opposite edges of the first housing 200 other than the edge connected to the second housing 100. The second engaging members 110 are disposed on opposite edges of the second housing 100 and correspond in position to the first engaging members 210, respectively. Each of the second engaging members 110 includes a main body 111 having a pivotal end 1110 pivotally mounted on the second housing 100, and an L-shaped protrusion 112 extending inwardly from the main body 111 and spaced apart from the pivotal end 1110. Each of the first engaging members 210 is configured as a block that is formed with a notch 211. The L-shaped protrusion 112 is configured for engaging removably the notch 211 so as to lock the second housing 100 to the first housing 200.

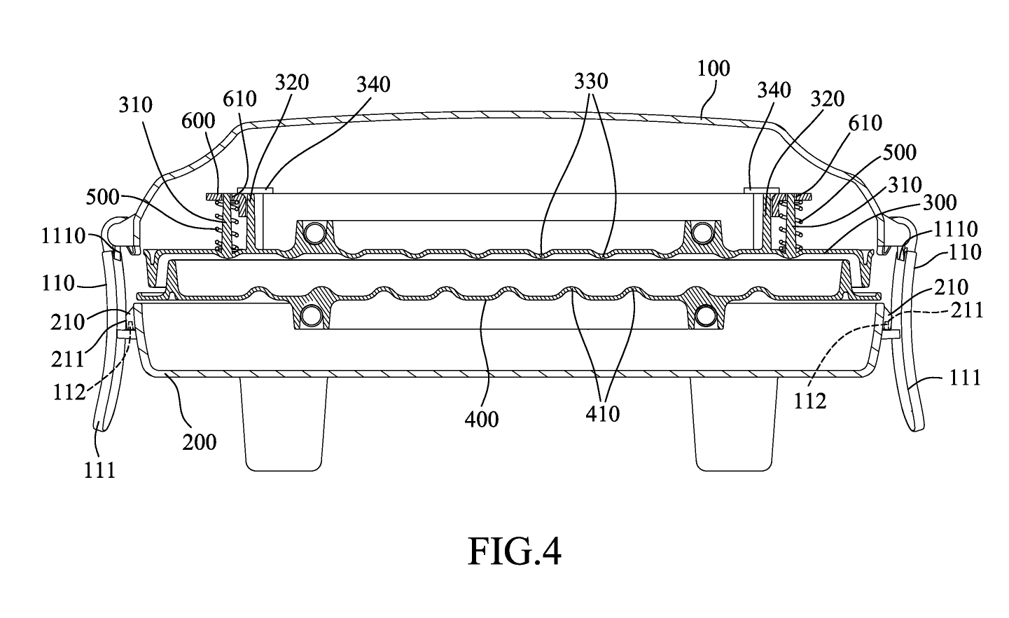

FIG. 4 illustrates the limiting members 340 attached to an upper surface of the connecting member 600 to limit movement of the second grilling plate 300 away from the connecting member 600. Referring to FIG. 5, when the food 800 is disposed between the first and second grilling plates 400, 300 and the first and second housings 200, 100 are locked together by the first and second engaging members 210, 110, the food 800 is clamped between the first and second grilling plates 400, 300. As a result, contact areas between the food 800 and the first grilling plate 400 and between the food 800 and the second grilling plate 300 can be increased, and heat from the first and second grilling plates 400, 300 can be transferred to the food 800 efficiently and effectively so as to decrease cooking time of the food 800 as well as evenly cook the food 800. For example, 25% cooking time is saved as compared to the conventional grill device. At this time, the second grilling plate 300 is pushed by the food 800 to move toward the second housing 100, and the limiting members 340 are detached from the connecting member 600. Additionally, the second grilling plate 300 is biased by a restoring force of the biasing members 500 toward the first grilling plate 400, such that food 800 with various sizes may be tightly clamped between the first and second grilling plates 400, 300. Moreover, since the food 800 is compressed tightly between the first and second grilling plates 400, 300, a relatively great amount of oil in the food 800 may be expelled therefrom. For example, oil expelled from the food 800 by the grill device of this embodiment is more than that expelled by the conventional grill device by 80%.

Note that each of the second engaging members 110 may includes more than one of the L-shaped protrusions 112. For example, when three of the L-shaped protrusions 112 are arranged along the main body 111, the force that the second grilling plate 300 exerted on the food 800 can be adjusted by engaging a selected one of the L-shaped protrusions 112 to the notch 211.

To sum up, the advantages of the grill device of the present invention are as follows. In the present invention, the first and second engaging members 210, 110 lock the first and second housings 200, 100 together to clamp the food 800 disposed therebetween, thus increasing contact areas between the food 800 and the first grilling plate 400 and between the food 800 and the second grilling plate 300 to thereby cook the food 800 in a relatively efficient and effective manner. Further, by virtue of the biasing members 500 that bias the second grilling plate 300 toward the first grilling plate 400, the food 800 with various size can be tightly clamped between the first and second grilling plates 400, 300 to expel excess oil from the food 800.

While the present invention has been described in connection with what is considered the most practical and preferred embodiment, it is understood that this invention is not limited to the disclosed embodiment but is intended to cover various arrangements included within the spirit and scope of the broadest interpretations and

What is claimed is:

1. A grill device comprising:
a first housing;
a first grilling plate mounted on said first housing;
a second housing pivotally connected to said first housing;
a second grilling plate mounted on said second housing, movable toward and away from said second housing, and facing said first grilling plate;
at least one first engaging member disposed on said first housing; and
at least one second engaging member disposed on said second housing and configured to removably engage said at least one first engaging member so as to lock said first housing to said second housing.

2. The grill device as claimed in claim 1, further comprising a connecting member interconnecting said second housing and said second grilling plate and connected fixedly to said second housing, and at least one biasing member disposed between said connecting member and said second grilling plate for biasing said second grilling plate away from said connecting member.

3. The grill device as claimed in claim 2, wherein said second grilling plate includes a confining member protruding toward said second housing, and at least one limiting member extending from a periphery of said confining member toward said connecting member and removably attached to said connecting member to confine said connecting member and to limit movement of said second grilling plate to a direction toward and away from said second housing.

4. The grill device as claimed in claim 3, comprising a plurality of said biasing members,
wherein said connecting member is formed with a plurality of through holes, and said second grilling plate includes a plurality of pillars extending through said through holes, respectively, and said biasing members being sleeved on said pillars, respectively.

5. The grill device as claimed in claim 4, wherein said connecting member is configured as a frame, said pillars of said second grilling plate surrounding said confining member.

6. The grill device as claimed in claim 1, wherein one of said first and second engaging members is configured as a block that is formed with a notch, and the other one of said first and second engaging members includes a main body having a pivotal end pivotally mounted on a corresponding one of said first and second housings, and an L-shaped protrusion extending from said main body, spaced apart from said pivotal end, and configured for engaging removably said notch.

7. The grill device as claimed in claim 6, comprising two of said first engaging members disposed on opposite edges of said first housing, and two of said second engaging members disposed on opposite edges of said second housing.
